(19) United States
(12) Patent Application Publication
(10) Pub. No.: US 2016/0291806 A1
(43) Pub. Date: Oct. 6, 2016

(54) CUSTOMIZABLE INSTRUMENT CLUSTER USER INTERFACE

(71) Applicant: Ford Global Technologies, LLC, Dearborn, MI (US)

(72) Inventors: Christian CIVIERO, Canton, MI (US); Cary Ochen DIEHL, Grosse Ile, MI (US); Joseph Angelo FODERA, Canton, MI (US); Paul James NAGAITIS, Rochester Hills, MI (US); Stavros DIONYSSOPOULOS, Grosse Ile, MI (US)

(21) Appl. No.: 14/677,205

(22) Filed: Apr. 2, 2015

(51) Int. Cl. G06F 3/0482; G06F 3/0484

(52) U.S. Cl. CPC G06F 3/0482; G06F 3/04847; G06F 3/04842

(57) ABSTRACT

A vehicle may include a display, human-machine-interface (HMI) controls, and an information display system. The information display system may receive input to the HMI controls to transition to a next screen in a sequence of bookmarked user-interface screens otherwise available, via the display, within a set of navigable categories of user-interface screens, and update the display to provide the next screen responsive to the input. A vehicle gauge cluster may be configured to when in an add/remove mode, adjust inclusion of screens within a sequence of bookmarked user-interface screens responsive to user input; when in a reorder mode, adjust ordering of screens within a sequence of bookmarked user-interface screens responsive to user input; and when in a view mode, cycle through screens in the sequence of bookmarked user-interface screens responsive to user input.

### TECHNICAL FIELD

Aspects of the disclosure generally relate to a customizable instrument cluster user interface.

### BACKGROUND

Many modern vehicles are equipped with electronic gauge clusters. Sometimes referred to as a digital dash, an electronic gauge cluster includes a set of vehicle instrumentation that may be displayed with a configurable digital readout or display panel, rather than with traditional analog gauges. Due to the configurable nature of the digital displays, electronic gauge cluster may be controlled by the user to display different elements of vehicle information.

### SUMMARY

In a first illustrative embodiment, a vehicle includes a display; human-machine-interface (HMI) controls; and an information display system configured to receive input provided to the HMI controls to transition to a next screen in a sequence of bookmarked user-interface screens otherwise available, via the display, within a set of navigable categories of user-interface screens; and update the display to provide the next screen responsive to the input.

In a second illustrative embodiment, a system includes a vehicle gauge cluster configured to, when in an add/remove mode, adjust inclusion of screens within a sequence of bookmarked user-interface screens responsive to user input; when in a reorder mode, adjust ordering of screens within the sequence of bookmarked user-interface screens responsive to user input; and when in a view mode, cycle through screens in the sequence of bookmarked user-interface screens responsive to user input.

In a third illustrative embodiment, a computer-implemented method includes in an edit mode, updating a sequence of bookmarked user-interface screens responsive to a selection of a user-interface screen within one of a set of navigable categories of user-interface screens accessible via a gauge-cluster vehicle display; and in a view mode, updating the gauge-cluster vehicle display to provide a next screen responsive to receiving input to transition to the next screen in the sequence of bookmarked user-interface screens.

### BRIEF DESCRIPTION OF THE DRAWINGS

FIG. 1 illustrates an example of a vehicle including a configurable display to facilitate communication of information with a driver;

FIG. 2 illustrates an example portion of a vehicle including steering wheel human-machine interface controls and a configurable display disposed within a dashboard of the vehicle;

FIG. 3A illustrates an example user interface including screens available within a trip/fuel category;

FIG. 3B illustrates an example user interface including screens available within a truck information category;

FIG. 3C illustrates an example user interface including screens available within a towing category;

FIG. 3D illustrates an example user interface including screens available within an off-road category;

FIG. 3E illustrates an example user interface including screens available within an settings category;

FIG. 3F illustrates an example user interface including bookmarked screens available within a favorites category;

FIG. 3G illustrates an example user interface for selecting to configure the screens available within the favorites category;

FIG. 3H illustrates an example user interface for selecting the category in which to add or remove the screens available within the favorites category;

FIGS. 3I and 3J illustrate example user interfaces for adding or removing the screens available within the favorites category;

FIGS. 3K, 3L, 3M and 3N illustrates example user interfaces for reordering the screens available within the favorites category;

FIG. 3O illustrates an example user interface for selecting the display of bookmarked screens available within the favorites category;

FIGS. 3P, 3Q and 3R illustrate example user interfaces for displaying bookmarked screen available within the favorites category;

FIG. 4 illustrates an example process for configuring the screens available within the favorites category;

FIG. 5 illustrates an example process for reordering the screens available within the favorites category; and

FIG. 6 illustrates an example process for selecting among the screens available within the favorites category.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Modern instrument clusters may include a display area capable of being switched to show one of dozens of available information screens. In an example, the instrument cluster may include a menu structure having set of categories, such as trip/fuel information, truck information, towing information, and off-road information. The menu structure may further include information screens placed at predefined locations within the defined categories.

When the user wishes to display information on one of these screens, the user may first select the category in which the screen is placed, and then select the screen from the selected category. However, as capabilities and information screens are added to the instrument cluster, it may become progressively more difficult for users to navigate the display area to the desired category and information screen. Additionally, it may be difficult for users to remember where in the menu structure a specific element of information is located. Nevertheless, despite the quantity of available information, many users only wish to switch among a small subset or sequence of the available information screens.

As improved instrument cluster may allow a user to configure a portion of a menu structure with a bookmarked sequence of favorite information screens. In many examples, the configuration of the bookmarked sequence may be performed when the vehicle is parked. Then, when the user is driving, the user may be able to quickly cycle through the sequence of favorite bookmarked screens for quick selection of information screen to be displayed in the gauge cluster.

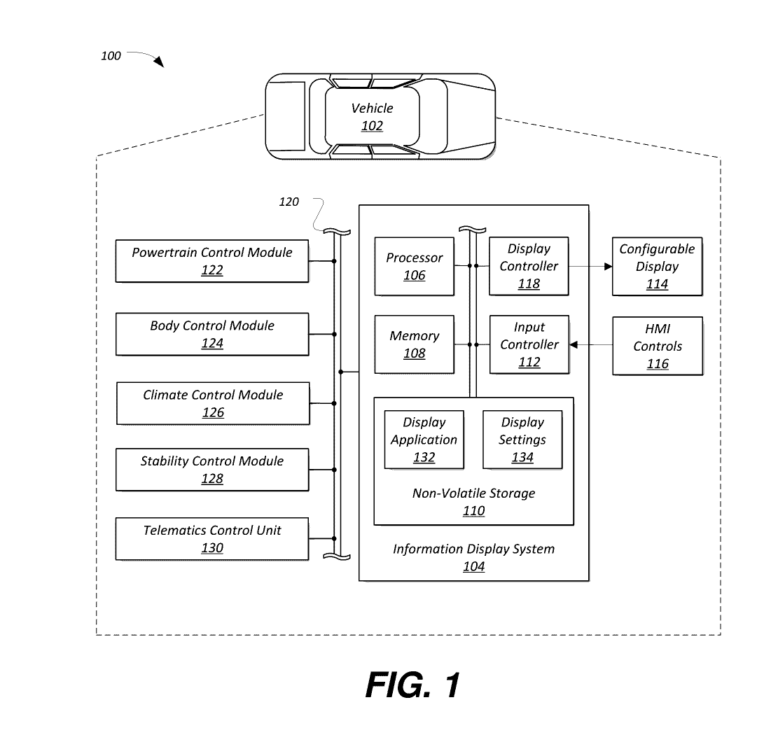

FIG. 1 illustrates an example 100 of a vehicle 102 including a configurable display 114 to facilitate communication of information with a driver. The vehicle 102 may include various types of passenger vehicle, such as crossover utility vehicle (CUV), sport utility vehicle (SUV), truck, recreational vehicle (RV), boat, plane or other mobile machine for transporting people or goods. It should be noted that the illustrated vehicle 102 is merely an example, and more, fewer, and/or differently located elements may be used.

An information display system 104 of the vehicle 102 may include one or more processors 106 configured to perform instructions, commands and other routines in support of the processes described herein. For instance, the information display system 104 may be configured to execute instructions of a display application 132 loaded to a memory 108 to provide information display features such as trip counters, fuel economy, fuel history, digital speedometer, engine information, and towing status. Such instructions and other data may be maintained in a non-volatile manner using a variety of types of computer-readable storage medium 110. The computer-readable medium 110 (also referred to as a processor-readable medium or storage) includes any non-transitory medium (e.g., a tangible medium) that participates in providing instructions or other data that may be read by the processor 106 of the information display system 104. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and PL/SQL.

The information display system 104 may be provided with various features allowing the vehicle occupants to interface with the information display system 104. For example, the information display system 104 may include an input controller 112 configured to receive user input from one or more human-machine interface (HMI) controls 116 of the vehicle 102 providing for occupant-vehicle interaction. These may include one or more buttons, knobs, or other controls configured to invoke functions on the information display system 104. The information display system 104 may also drive or otherwise communicate with one or more configurable displays 114 configured to provide visual output to vehicle occupants by way of a display controller 118.

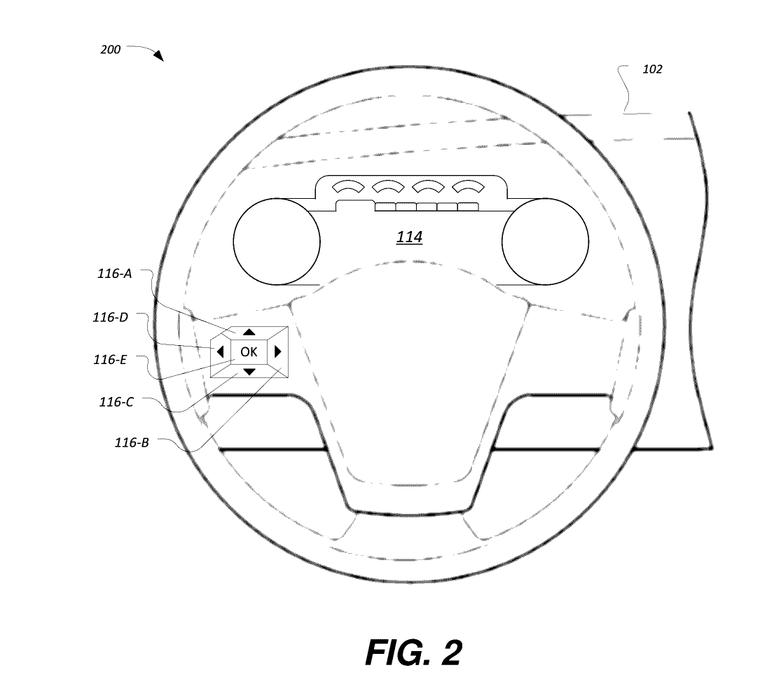

As shown in FIG. 2, the HMI controls 116 may include a set of steering wheel controls including an up HMI control 116-A, a right HMI control 116-B, a down HMI control 116-C, a left HMI control 116-D, and an OK/select HMI control 116-E. It should be noted, however, that these HMI controls 116 mare merely one example. As some other possibilities, the HMI controls 116 may additionally or alternatively include instrument panel controls, other steering wheel controls, and/or voice commands in a grammar utilized by a voice recognition system of the vehicle 102.

Also as shown in FIG. 2, the configurable display 114 may be disposed within a dashboard of the vehicle 102, such as within the instrument panel cluster. In other examples, the configurable display 114 may be part of another display system, such as the navigation system, or may be part of a dedicated information display system elsewhere in the vehicle 102. The configurable display 114 may be a liquid crystal display (LCD), a plasma display, an organic light emitting display (OLED), or any other suitable display. In some cases, the configurable display 114 may be a touch screen further configured to receive user touch input via the display controller 118, while in other cases the configurable display 114 may be a display only, without touch input capabilities, such as when included within the instrument cluster behind the steering wheel.

Referring back to FIG. 1, the information display system 104 may be further configured to communicate with other components of the vehicle 102 via one or more in-vehicle buses 120. The in-vehicle buses 120 may include one or more of a vehicle controller area network (CAN), an Ethernet network, and a media oriented system transfer (MOST), as some non-limiting possibilities. The in-vehicle buses 120 may allow the information display system 104 to communicate with other vehicle 102 systems. The exemplary vehicle systems described in detail below may communicate with the information display system 104 over an in-vehicle bus 120. In other examples, the information display system 104 may be connected to more or fewer in-vehicle buses 120, and one or more HMI controls 116 or other components may be connected to the information display system 104 via in-vehicle buses 120 or directly without connection to an in-vehicle bus 120.

In an example, a powertrain control module 122 may be a component in communication with the information display system 104, and may be configured to provide information to the information display system 104 regarding control of engine operating components (e.g., idle control, fuel delivery, emissions control, engine diagnostic codes, etc.). A body control module 124 may be configured to manage various power control functions such as exterior lighting, interior lighting, keyless entry, remote start, and provide information to the information display system 104 such as point of access status information (e.g., closure status of the hood, doors and/or trunk of the vehicle 102). A climate control module 126 may be configured to provide control and monitoring of heating and cooling system components, as well as to provide information to the information display system 104 regarding the components (e.g., compressor clutch and blower fan control, temperature sensor information, etc.). A stability control module 128 may be configured to perform functions such as active suspension control, traction control, and brake control, and provide sensed vehicle dynamics information to the information display system 104, such as roll angle, pitch angle, yaw rate, roll rate, pitch rate, lateral and longitudinal velocity, lateral and longitudinal acceleration, tire slip, tire slip rate, and an infotainment system module. A telematics control module 130 may include an in-vehicle modem configured to access communications services of a communications network (not shown), and may provide packet-switched network services (e.g., Internet access, voice over Internet protocol (VoIP) communication services) to the information display system 104 and to other devices connected over the in-vehicle bus 120.

A display application 132 may be installed to the information display system 104 and utilized to allow the vehicle 102 to provide output to the display controller 118, such that the configurable display 114 conveys the information relating to the operation of the vehicle 102 to the driver. In an example, the display application 132 may be configured to provide a menu structure via the configurable display 114 having set of categories into which information screens are placed, such as trip/fuel, truck information, towing, and off-road. The menu structure may further include information screens that may be selected from the categories. For instance, the trip/fuel category may include a trip counter screen for a first trip counter, a trip counter screen for a second trip counter, a fuel economy screen, a fuel history screen, and a navigation/compass screen. As more examples, the truck information category may include a gauge selection screen, a tire pressure screen, a digital speedometer screen, an engine information screen, and a key status screen. As some further examples, the towing category may include a towing status screen, a towing information screen, a trailer light status screen, a trailer setup screen, and a connection checklist screen, and the off-road category may include an off-road status screen and a power distributions screen. When a screen is selected from the menu structure (e.g., via user input to the HMI controls 116), the selected screen may be provided on the configurable display 114.

As shown in greater detail below, the display application 132 may be further configured to allow a user to configure a portion of a menu structure with a bookmarked sequence of favorite information screens. Accordingly, when driving the user may be able to quickly cycle through the sequence of favorite previously-bookmarked screens for quick selection of information screen to be displayed by the information display system 104 on the configurable display 114.

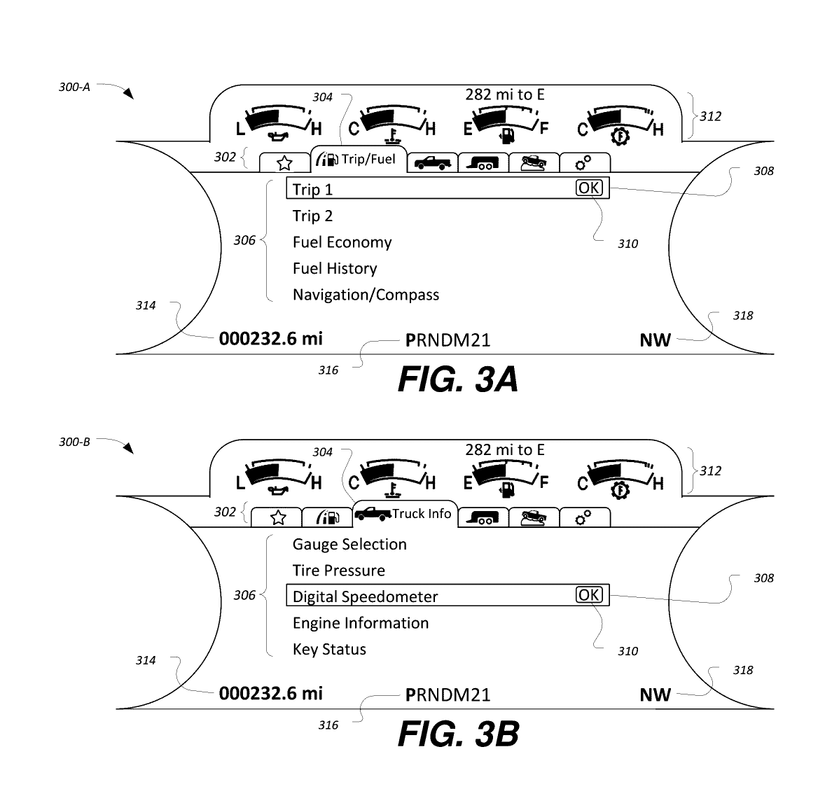

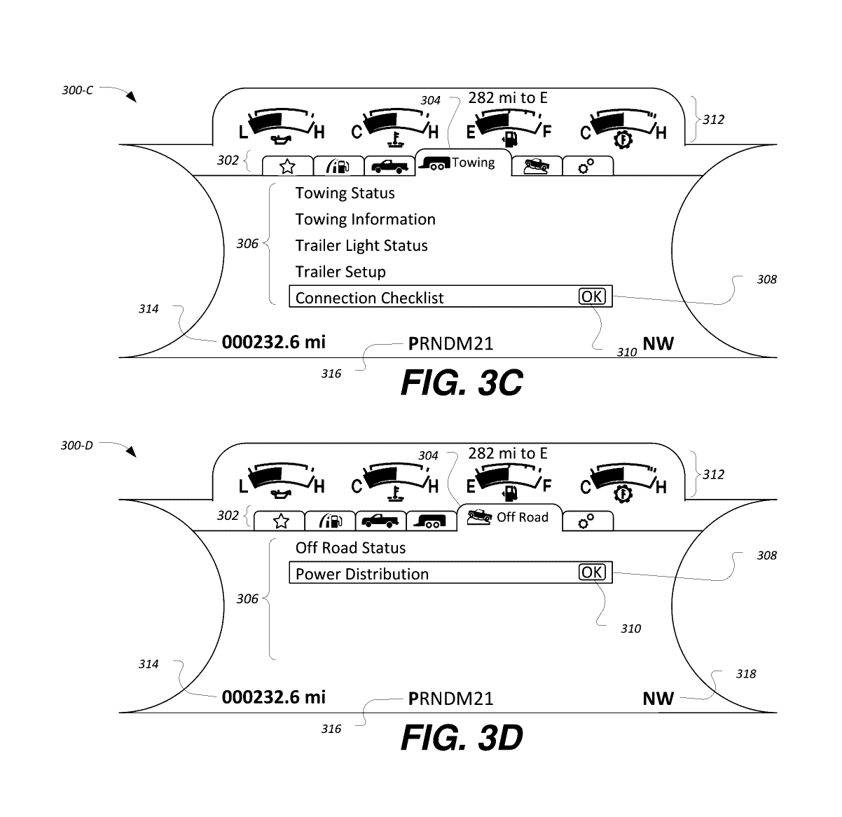

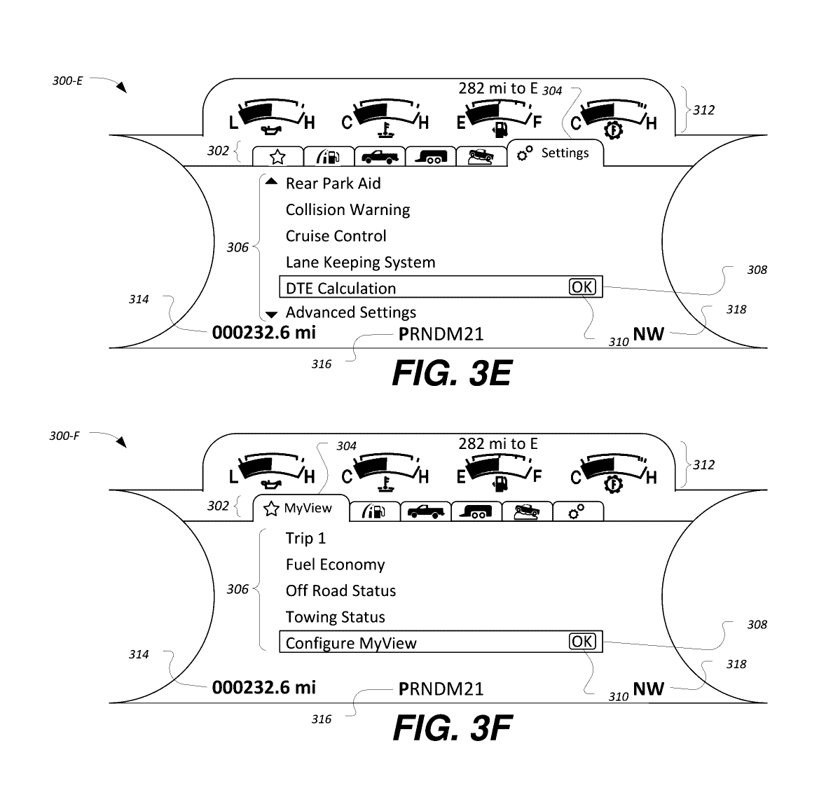

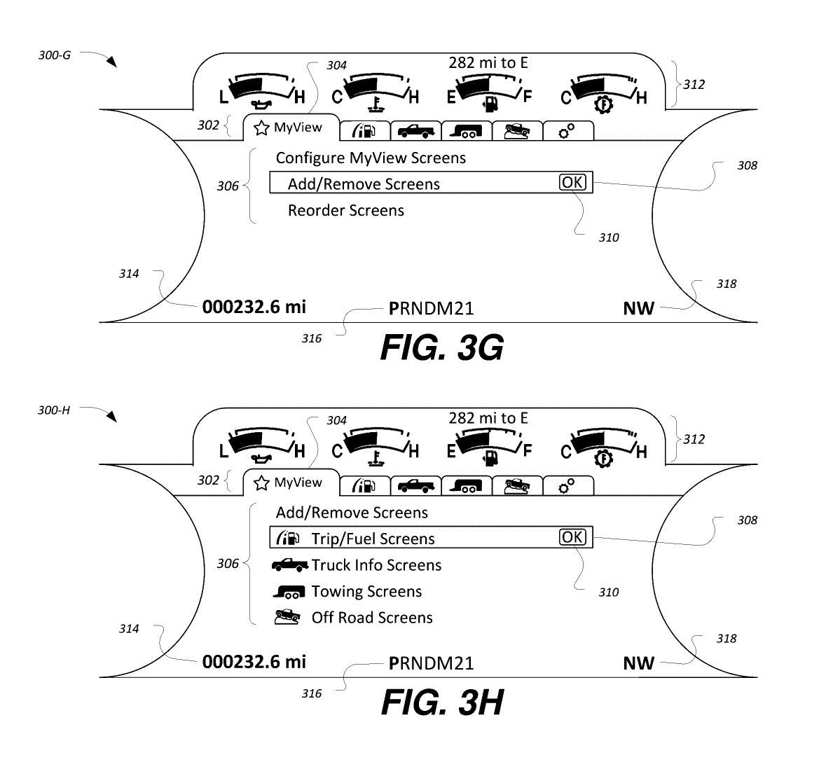

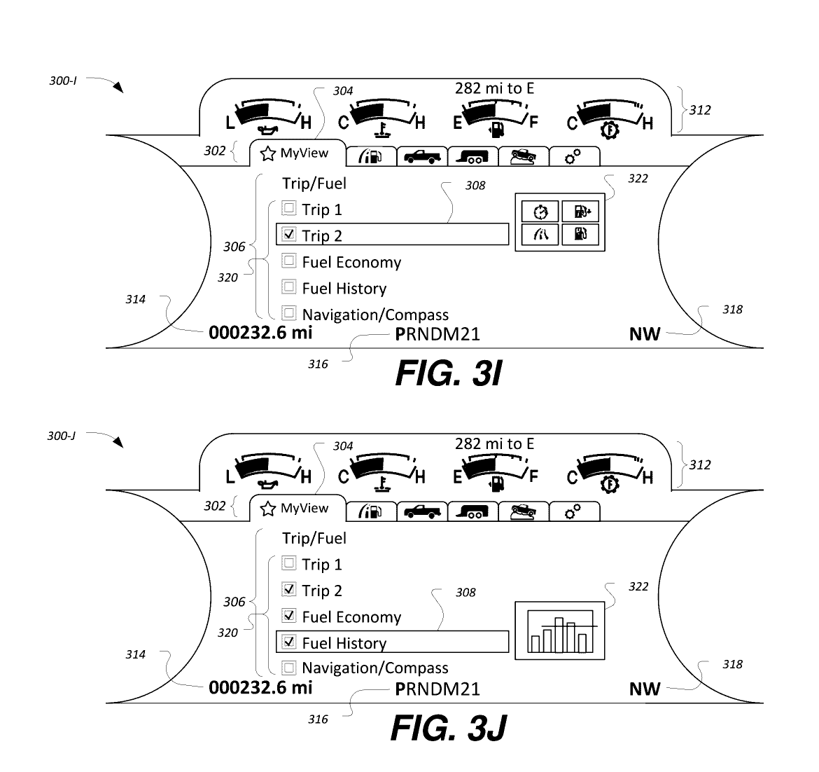

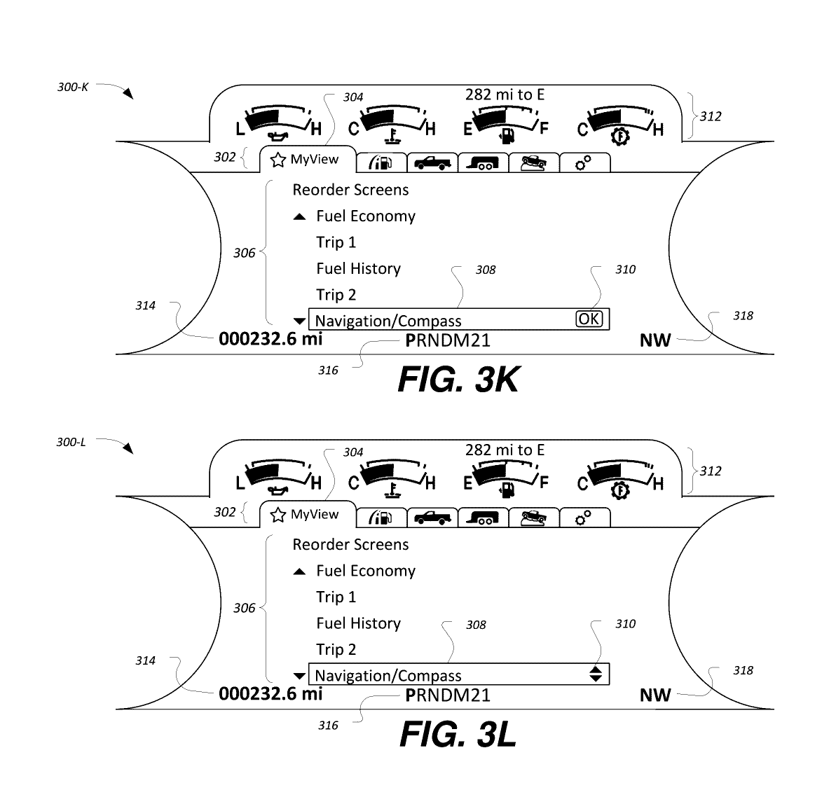

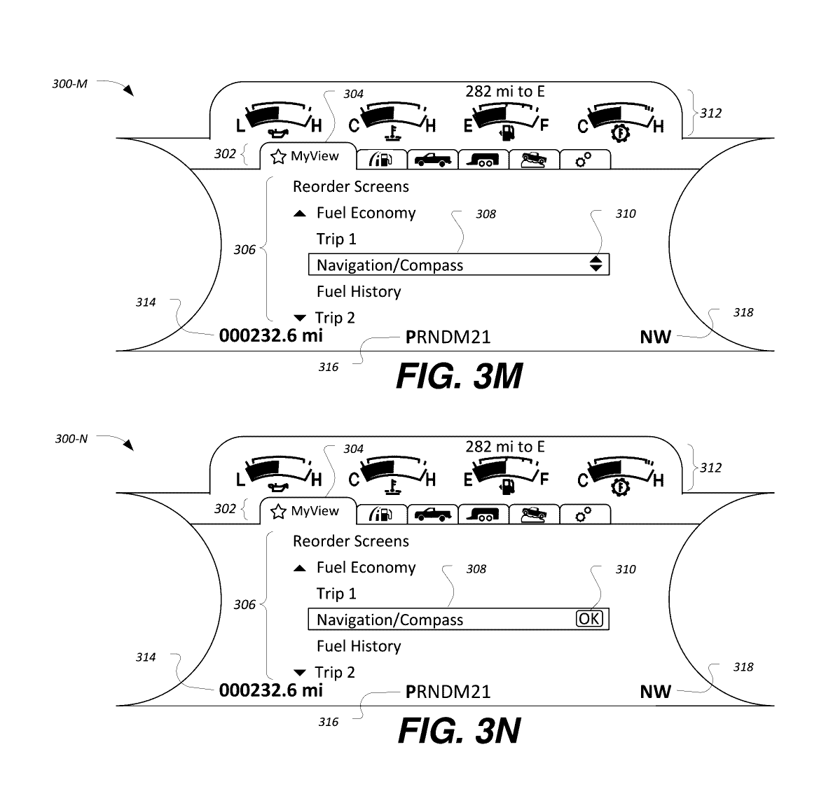

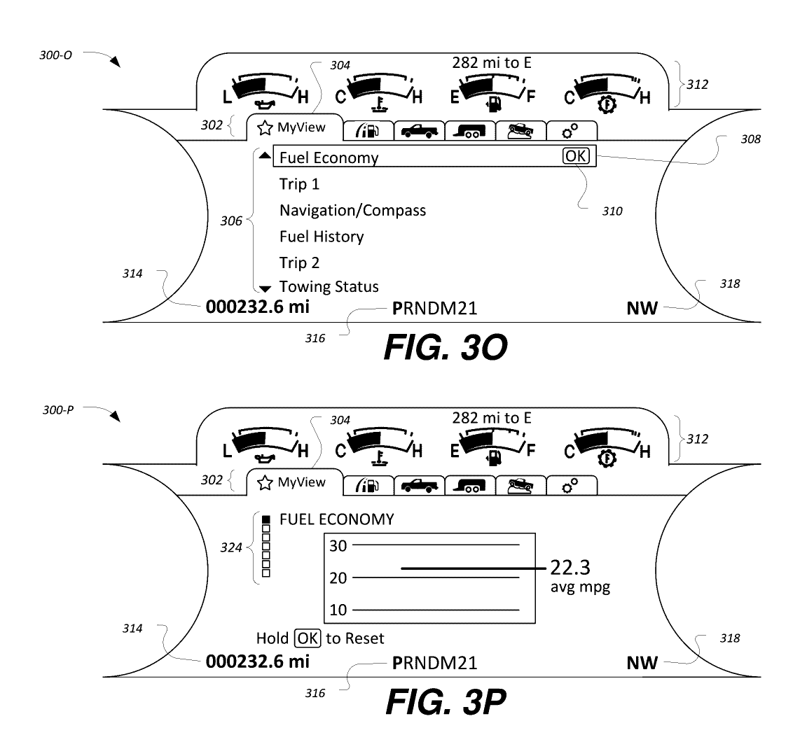

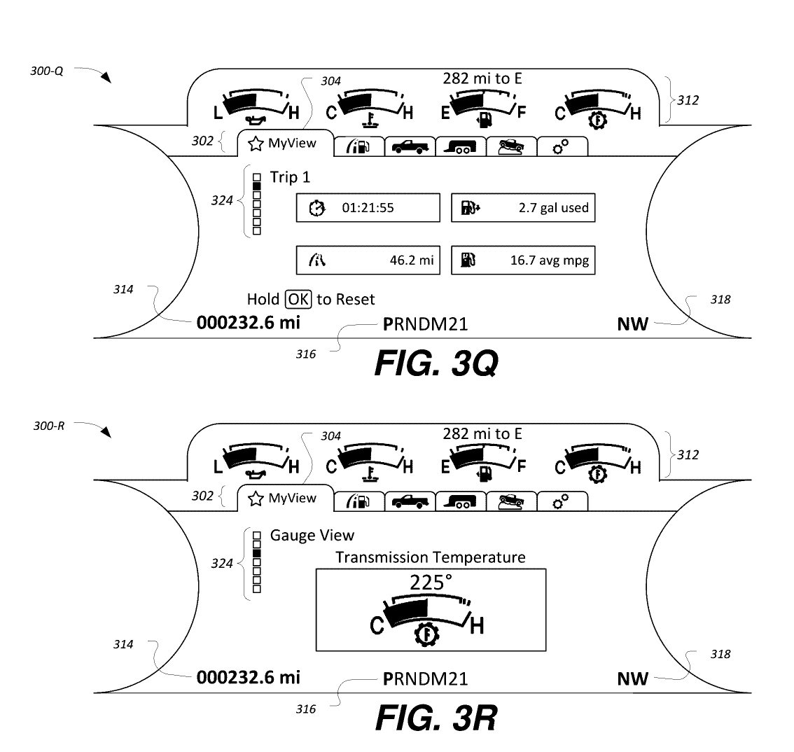

Referring generally to FIGS. 3A-3R, the configurable display 114 is shown in greater detail in accordance with one or more aspects of the display application 132. As seen therein, the configurable display 114 may display one or more user interfaces 300 that change to convey different information to the driver. To that end, the one or more users interfaces 300 may be selectable upon receipt of driver or vehicle input to the information display system 104 from the HMI controls 116. While the illustrated user interfaces 300 are displayed in a particular layout and in the English language, it should be noted that different languages or layouts of content may be used. For instance, the language of the content may be adjustable via a settings menu of the user interface 300.

FIG. 3A illustrates an example user interface 300-A including screens available within a trip/fuel category. In an example, the user interface 300-A may be presented by the display application 132 in the configurable display 114.

Among other elements, the user interface 300-A may include a tab control 302 configured to indicate a various available categories of information. The tab control 302 may operate as a menu, such that a user of the user interface 300-A may be able to switch through the tabs of the tab control 302, e.g., using the right HMI control 116-B to move to the next tab and the left HMI control 116-D to move to the previous tab. Moreover, the tab control 302 may further illustrate the currently-selected tab 304 to distinguish it from the other tabs. In the illustrated example, the currently-selected tab 304 may be illustrated as larger than the other tabs of the tab control 302 and with the textual name of the tab 304, while the other tabs may be illustrated as of a smaller size and with only an icon but no textual name. It should be noted that this is merely, one example, and other forms of tab control 302 and indicated selection of the currently-selected tab 304 may be utilized as well.

The user interface 300-A may further include additional display elements dependent on the section of a tab 304 from the tab control 302. For instance, the user interface 300-A may include a list control 306 including a set of selectable elements related to the selected tab 304 of the tab control 302. The list control 306 may also operate as a menu, such that a user of the user interface 300-A may be able to scroll through list entries of the list control 306, e.g., using the up HMI control 116-A to scroll up and the down HMI control 116-C to scroll down. As shown, the “Trip/Fuel” tab is presently selected in the tab control 302, and within that tab the “Trip 1” item of the list control 306 is indicated by highlight 308 as being the currently-selected item. As further illustrated by the icon 310 in the currently-selected item, the user may further be able to use the select HMI control 116-E to invoke the selected item of the list control 306. Thus, the user may be able to identify from the user interface 300-A that pressing the HMI control 116-E would invoke display of the “Trip 1” display screen. As another example, the vehicle HMI may support voice command selection of the menu items. For example, to invoke the “Trip 1” list item, the user may press a push-to-talk button within the vehicle 102, and may speak the voice command “Trip 1.” An example of the “Trip 1” display screen is illustrated in FIG. 3Q and discussed below

The user interface 300-A may also include additional display elements that are independent of the section of a tab from the tab control 302. For instance, the user interface 300-A may include a set of gauges 312 configured to display general information regarding the status of the vehicle 102. As shown, the gauges 312 include an oil temperature gauge, a coolant temperature gauge, a fuel gauge, and a transmission temperature gauge, but these are merely examples and fewer, different or additional gauges 312 may be displayed as well. As some other possibilities, the user interface 300-A may illustrate an odometer 314 to indicate to the user the total miles traveled, a gear indication 316 indicating the currently selected gear, and a direction indication 318 indicating the direction in which the vehicle 102 is facing.

Referring more specifically to the screens available within the trip/fuel category, the list control 306 may include entries for screens such as a “Trip 1” screen configured to display information for a first trip counter, a “Trip 2” screen configured to display information for a second trip counter, a “Fuel Economy” screen configured to display vehicle 102 fuel economy information, a “Fuel History” screen configured to display historical vehicle 102 fuel economy or usage information, and a “Navigation/Compass” screen configured to display a compass and/or other navigational information.

FIG. 3B illustrates an example user interface 300-B including screens available within a truck information category. For instance, within the trip/fuel category, the list control 306 may include entries for screens such as a “Gauge Selection” screen configured to display particular additional gauges selected by the user, a “Tire Pressure” screen configured to display information for current tire pressure for each tire, a “Digital Speedometer” screen configured to display current vehicle 102 speed information, an “Engine Information” screen configured to display current engine status information, and a “Key Status” screen configured to allow the user to view and possibly adjust current key settings for the vehicle 102.

FIG. 3C illustrates an example user interface 300-C including screens available within a towing category. For instance, within the towing category, the list control 306 may include entries for screens such as a “Towing Status” screen, a “Towing Information” screen, a “Trailer Light Status” screen, a “Trailer Setup” screen, and a “Connection Checklist” screen.

FIG. 3D illustrates an example user interface 300-D including screens available within an off-road category. For instance, within the off-road category, the list control 306 may include entries for screens such as an “Off Road Status” screen and a “Power Distribution” screen.

FIG. 3E illustrates an example user interface 300-E including screens available within a settings category. For instance, within the settings category, the list control 306 may include entries for screens such as a “Rear Park Aid” settings screen, a “Collision Warning” settings screen, a “Cruise Control” settings screen, a “Lake Keeping System” settings screen, a “DTE Calculation” distance to empty settings screen, and a further category for advanced settings.

When the user wishes to display information on one of these screens, the user may first select the category in which the screen is placed, and may then select the screen from the selected category. However, it may be difficult for users to remember where in the menu structure a specific element of information may be listed. Despite the quantity of available information, many users only wish to switch among a small subset or sequence of the available information screens.

FIG. 3F illustrates an example user interface including bookmarked screens available within a favorites category. The favorites category may be include a predetermined sequence of bookmarked information screens from the other categories of screens. When driving, the user may be able to quickly cycle through the sequence of favorite bookmarked screens for quick selection of information screen to be displayed in the gauge cluster.

As shown, the list control 306 includes bookmarked entries for the “Trip 1” screen from the trip/fuel category, the “Fuel Economy” screen from the trip/fuel category, the “Off Road Status” screen from the off-road category, and the “Towing Status” screen from the towing category. Similar to use of the categories described above, a user may be able to select screens for viewing from the listing of bookmarked entries. Notably, the user may be able to do so without having to first select the category in which the screen is categorized, and then select the individual screen from the category. It should be noted that the illustrated bookmarked entries are merely examples, and more, fewer, and/or different bookmarked screens may be displayed.

The favorites category may further include a facility to provide for user configuration of the bookmarked screens. In an example, the list control 306 may include a configure option in the list control 306 that, when selected, provides the user with options for the configuration of the bookmarked screens. For example, the user may scroll to the configure item of the list control 306 using the up HMI control 116-A or down HMI control 116-C, and may choose the configure option using the select HMI control 116-E to display the configure user interface.

FIG. 3G illustrates an example user interface 300-G for selecting to configure the screens available within the favorites category. In an example, the list control 306 may include a category indication that user interface 300-G is displaying options for the configuration of the favorite bookmarked screens, as well as options to select to add/remote screens from the favorites category and to reorder screens currently placed in the favorites category. For example, the user may scroll to the add/remove or reorder options of the list control 306, e.g., using the up HMI control 116-A and/or down HMI control 116-C, and may choose the desired option, e.g., using the select HMI control 116-E. The add/remove option is described in detail with respect to FIGS. 3H-3J, and the reorder screens option is described in detail with respect to FIGS. 3K-3N.

FIG. 3H illustrates an example user interface 300-H for selecting the category in which to add or remove the screens available within the favorites category. In an example, the list control 306 may include a category indication that user interface 300-H is displaying options for adding or removing favorites screens, as well as options to select from the available categories of screens for selection or deselection. As shown, the list control 306 includes options to select from the trip/fuel category (e.g., as shown above with respect to the user interface 300-A in FIG. 3A), the truck information category (e.g., as shown above with respect to the user interface 300-B in FIG. 3B), the towing category (e.g., as shown above with respect to the user interface 300-C in FIG. 3C), and the off-road category (e.g., as shown above with respect to the user interface 300-D in FIG. 3D). In an example, the user may scroll to the desired category of screens using the up HMI control 116-A and/or down HMI control 116-C, and may choose the desired option using the select HMI control 116-E. To facilitate easy identification of the categories to the user, the screen category entries in the list control 306 may utilize the same corresponding icons as used in the categories displayed in the tab control 302. While not shown, the list control 306 may also include options to select from the settings category (e.g., as shown above with respect to the user interface 300-E in FIG. 3E).

FIG. 3I illustrates an example user interface 300-I for adding or removing the screens available within the favorites category. In an example, the user interface 300-I may be displayed responsive to selection of the trip/fuel category from the list control 306 of the user interface 300-H. The list control 306 may accordingly include a category indication that user interface 300-G is displaying available screens from the selected category (e.g., the “Trip/Fuel” category in the illustrated example) for adding or removing favorites screens, as well as a listing of the available screens in the trip/fuel category (e.g., an example of which is displayed in the user interface 300-A).

A user of the user interface 300-I may scroll through list entries of the list control 306, e.g., using the up HMI control 116-A to scroll up and the down HMI control 116-C to scroll down, and may, for example, use the select HMI control 116-E to choose items of the list control 306. Rather than causing the display application 132 to display the selected screen, choosing items from the user interface 300-I may instead cause the display application 132 to add or remove the selected screen from the favorites category.

To allow the user to easily identify which screens are selected for inclusion in the favorites category, the user interface 300-I include a set of selection controls 320 (e.g., checkboxes) that may be used to visually display which screens are selected. As shown in the user interface 300-I the selection controls 320 indicate that the “Trip 2” screen is selected, while the other screens in the trip/fuel category are not.

The user interface 300-I may also include a preview indication 322 configured to provide a simplified view of the selected screen within the list control 306. The preview indication 322 may accordingly provide the user with additional visual cues to aid in the selection of desired screens to be included in the favorites category. For instance, as shown the preview indication 322 illustrates an example of the general layout of information for the currently highlighted “Trip 2” screen.

In some cases, the sequence of favorites screens may include a maximum number of screens. In such an example, if the user attempts to add screens in excess of the maximum number, the display application 132 may display an error message in the user interface 300-I indicating that the maximum number of bookmarks have been used. To add an additional screen, the user may be required to deselect one of the currently bookmarked screens. As one non-limiting example, the bookmarks may include seven screens. As some other examples, the bookmarks may include one screen, three screens, four screens, eight screens, ten screens, or even an unlimited list of screens.

FIG. 3J illustrates an additional example user interface 300-J for adding or removing the screens available within the favorites category. As compared to the user interface 300-I, in the user interface 300-J the user has further selected the “Fuel Economy” screen and the “Fuel History” screen, and the preview indication 322 is displaying a preview of the currently highlighted “Fuel History” screen.

FIG. 3K illustrates an example user interface 300-K for reordering the screens available within the favorites category. The user interface 300-K may be displayed, in an example, responsive to user selection of the reorder screens option from the user interface 300-G. For instance, a user may wish to change placement of the “Navigation/Compass” screen in the favorites category. To do so, the user may use the HMI controls 116 to move to and select the “Navigation/Compass” item of the list control 306. For instance, the user may use the up HMI control 116-A to scroll up, the down HMI control 116-C to scroll down, and the select HMI control 116-E to choose items of the list control 306.

As shown in the user interface 300-L of FIG. 3L, when selected the icon 310 of the “Navigation/Compass” item of the list control 306 may be updated to reflect that the HMI controls 116 may now be used to adjust the position of the selected item, rather than to change which item is selected. In an example, the icon 210 may include up and down arrows to indicate that the HMI controls 116 may be used to adjust the position of the selected item, as compared to the “OK” icon utilized to indicate selection of list control 306 elements. When in position adjustment mode, the user may use the up HMI control 116-A to move the selected item up, the down HMI control 116-C to move the selected item down, and the select HMI control 116-E to place the item at the new location and revert to selection mode. Continuing the illustrated example of the user interface 300-K and the user interface 300-L, in the user interface 300-M of FIG. 3M, the user has moved the “Navigation/Compass” item up in the list control 306, and in the user interface 300-N of FIG. 3N, the user has placed the “Navigation/Compass” at the moved location.

FIG. 3O illustrates an example user interface 300-O for selecting the display of bookmarked screens available within the favorites category. In an example, the user may navigate to the user interface 300-O using the HMI controls 116 (e.g., using the left HMI control 116-D and/or right HMI control 116-A to switch to the favorites tab of the tab control 302 from another of the tabs). To view one of the screens bookmarked into the favorites list, the user may use the select HMI control 116-E to choose a screen from the list control 306, similar as would be done to select a screen from viewing from one of the predefined category tabs (e.g., trip/fuel, truck information, towing, off-road, settings, etc.) As shown, the favorites screens include the “Fuel Economy” screen as the first bookmarked screen, followed by the “Trip 1” screen, followed by the “Navigation/Compass” screen, followed by the “Fuel History” screen, followed by the “Trip 2” screen, followed by the “Towing Screen,” and so on.

FIG. 3P illustrates an example user interface 300-P for displaying a bookmarked screen available within the favorites category. In an example, the user interface 300-P may be displayed responsive to the user selecting to view the “Fuel Economy” screen from the user interface 300-O (e.g., via pressing the select HMI control 116-E).

The user interface 300-P may further include a page indication 324 of which one of the sequence of bookmarked screens is currently being displayed. For instance, as the first of a sequence of seven example bookmarked screens is currently being displayed in the user interface 300-P, the first box of the seven boxes of the page indication 324 is displayed as highlighted.

The user may utilize the HMI controls 116 to switch among the sequence of bookmarked screens. For example, the display application 132 may transition the user interface to the next bookmarked screen of the sequence of bookmarked screens responsive to selection of the down HMI control 116-B, and may transition the user interface to the previous bookmarked screen of the sequence of bookmarked screens responsive to selection of the up HMI control 116-D.

For instance, responsive to user selection to transition to the next bookmarked screen from the user interface 300-P, the display application 132 may display the “Trip 1” screen as shown in the user interface 300-Q, and responsive to further user selection to transition to the next bookmarked screen, the display application 132 may display the “Trip 1” screen as shown in the user interface 300-R. The display application 132 may further update the page indication 324 to indicate the updated location within the favorites bookmarks. In some examples, the sequence of bookmarked screens may wrap around, such that choosing the next screen on the last screen moves to the first screen, and choosing the previous screen from the first screen moves to the last screen.

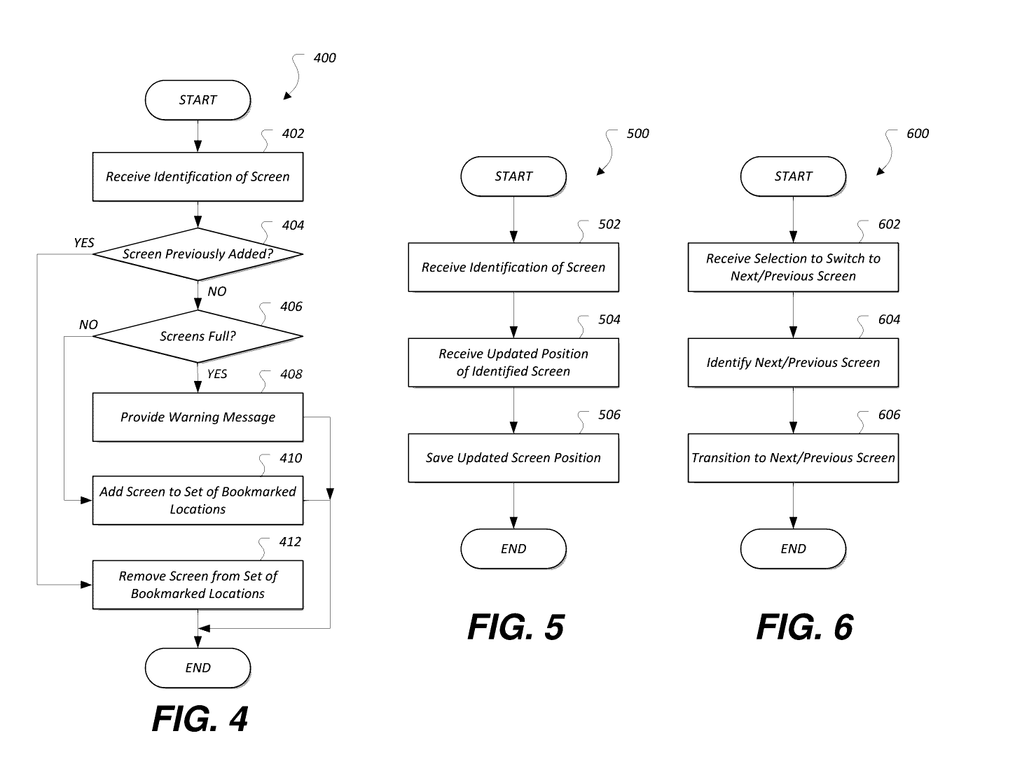

FIG. 4 illustrates an example process 400 for configuring the screens available within the favorites category. In an example, the process 400 may be performed by the information display system 104 in communication with the configurable display 114 and the HMI controls 116, and executing the display application 132 using the processor 106. It should be noted that in some examples, configuration of the screens within the favorites category may be disabled when the vehicle 102 is in motive mode, such as when the vehicle 102 is placed in drive or reverse, or when the vehicle 102 is traveling above a predefined speed (e.g., 5 miles per hour).

At operation 402, the information display system 104 receives an identification of a screen from the user interface 300. In an example, the user may utilize the HMI controls 116 to enter add/remove mode of the favorites tab as shown in the user interfaces 300-F, 300-G, and may further select a screen as shown in the user interfaces 300-H, 300-I and 300-J.

At operation 404, the information display system 104 determines whether the selected screen has been previously added to the bookmarked screens. In an example, the display application 132 may maintain display settings 134 indicative of which of the screens are presently included in the bookmarked screens, and may query the display settings 134 to identify whether the selected screen is currently included in the bookmarked screens. If the screen is currently included in the bookmarked screens, control passes to operation 412. Otherwise control passes to operation 406.

At operation 406, the information display system 104 determines whether the bookmarked screens area full. In an example, the display application 132 may maintain up to a maximum number of bookmarked screens in the display settings 134, and may query the display settings 134 to identify whether the maximum number of screens are already included in the bookmarks. If the bookmarks are deemed to be full, control passes to operation 408. Otherwise, control passes to operation 410.

At operation 408, the information display system 104 provides a warning message to the user. In an example, the display application 132 may provide an error message in the configurable display 114 indicating that the bookmarks are full, and that the user must remove a bookmark before an additional screen can be added.

At operation 410, the information display system 104 adds the selected screen to the bookmarked screens. In an example, the display application 132 may indicate in the display settings 134 that the selected screen is added to the bookmarks. The display application 132 may further update the user interface 300, e.g., by including a checkbox by the selected screen.

At operation 412, the information display system 104 removes the selected screen from the bookmarked screens. In an example, the display application 132 may indicate in the display settings 134 that the selected screen no longer included in the bookmarks. The display application 132 may further update the user interface 300, e.g., by removing a checkbox by the deselected screen.

After operations 408, 410, or 412, the process 400 ends. In other examples, after operations 408, 410, or 412 the process 400 may continue back to operation 402 to receive identification of additional screens.

FIG. 5 illustrates an example process 500 for reordering the screens available within the favorites category. As with the process 400, the process 500 may be performed by the information display system 104 in communication with the configurable display 114 and the HMI controls 116, and executing the display application 132 using the processor 106. As mentioned above, configuration of the screens within the favorites category may be disabled in some examples when the vehicle 102 is in motive mode.

At operation 502, the information display system 104 receives an identification of a screen from the user interface 300. In an example, the user may utilize the HMI controls 116 to enter reorder mode of the favorites tab as shown in the user interfaces 300-F and 300-G, and may further select a screen to reorder as shown in the user interfaces 300-K.

At operation 504, the information display system 104 receives an updated position of the identified screen. In an example, the user may utilize the HMI controls 116 to move the screen as shown in the user interfaces 300-L, 300-M, and 300-N.

At operation 506, the information display system 104 saves the updated screen position. In an example, responsive to receiving the updated screen position, the display application 132 may indicate in the display settings 134 the new ordering of the selected screen in the bookmarks. After operation 506, the process 500 ends.

FIG. 6 illustrates an example process 600 for selecting among the screens available within the favorites category. As with the processes 400 and 500, the process 600 may be performed by the information display system 104 in communication with the configurable display 114 and the HMI controls 116, and executing the display application 132 using the processor 106. With respect to the process 600, in an example, the user may have utilized the HMI controls 116 to select the favorites tab from the tab control 302 as shown in the user interface 300-O, and further to select a screen to display within the bookmarks as shown in the user interface 300-P. In many cases, navigation among the bookmarked screens within the favorites category may be enabled whether or not the vehicle 102 is in motive mode.

At operation 602, the information display system 104 receives a selection to switch to a next or previous screen of the bookmarked screens. In an example, the user may utilize the HMI controls 116 to select another of the screens (e.g., to use the down HMI control 116-B to select to move to the next screen, or the up HMI control 116-D to select to move to the previous screen).

At operation 604, the information display system 104 identifies the next or previous screen. In an example, the display settings 134 may include an ordering of screens (e.g., as configured using the processes 400 and 500) and the display application 132 may utilize the display settings 134 to identify the next or previous screen.

At operation 606, the information display system 104 transitions to the identified next or previous screen. In an example, the display application 132 may display the identified screen as determined at operation 604. The display application 132 may further update the page indication 324 to indicate to the user the new placement within the sequence of bookmarked screens. After operation 606, the process 600 ends.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle comprising:
a display;
human-machine-interface (HMI) controls; and
an information display system configured to
receive input provided to the HMI controls to transition to a next screen in a sequence of bookmarked user-interface screens otherwise available, via the display, within a set of navigable categories of user-interface screens; and
update the display to provide the next screen responsive to the input.

2. The vehicle of claim 1, wherein the information display system is further configured to provide, in the display, a page indication descriptive of where in the sequence of bookmarked user-interface screens the next screen is located.

3. The vehicle of claim 1, wherein the information display system is further configured to maintain display settings indicative of which of the user-interface screens otherwise available within the set of categories of user-interface screens are included in the sequence of bookmarked user interface screens.

4. The vehicle of claim 3, wherein the information display system is further configured to maintain display settings indicative of ordering of the user-interface screens included in the sequence of bookmarked user-interface screens, and identify the next screen in the sequence of bookmarked user-interface screens according to the ordering.

5. The vehicle of claim 1, wherein the information display system is further configured to present the bookmarked screens as a category of user-interface screens accompanying the set of navigable categories of user-interface screens.

6. The vehicle of claim 5, wherein the information display system is further configured to present the set of navigable categories of user-interface screens and the bookmarked screens category as tabs within the display.

7. The vehicle of claim 1, wherein the information display system is further configured to receive second user selection input to the HMI controls to transition to at least one of: (i) an add/remove mode supporting configuration of which of the user-interface screens are included in the sequence of bookmarked user-interface screens; and (ii) a reorder mode supporting configuration of an order in which of the user-interface screens are included in the sequence of bookmarked user-interface screens.

8. The vehicle of claim 7, wherein the information display system is further configured to allow the transition to a next screen in a sequence of bookmarked user-interface screens when the vehicle is in motive mode, but, when the vehicle is in motive mode prevent the transition into at least one of the add/remove mode and the reorder mode.

9. The vehicle of claim 1, wherein the display is included in a gauge cluster of the vehicle, and the human-machine-interface (HMI) controls include controls of a steering wheel of the vehicle.

10. A system comprising:
a vehicle gauge cluster configured to
when in an add/remove mode, adjust inclusion of screens within a sequence of bookmarked user-interface screens responsive to user input;
when in a reorder mode, adjust ordering of screens within the sequence of bookmarked user-interface screens responsive to user input; and
when in a view mode, cycle through screens in the sequence of bookmarked user-interface screens responsive to user input.

11. The system of claim 10, wherein the vehicle gauge cluster is further configured to prevent transition into the add/remove mode and the reorder mode when the vehicle is in motive mode.

12. The system of claim 10, wherein each of the screens is included in at least one of a set of navigable categories of user interface screens, the navigable categories including at least two of a trip/fuel category, a truck information category, a towing category, and an off-road category.

13. The system of claim 10, wherein the user input is received via human-machine-interface (HMI) controls of the vehicle.

14. The system of claim 13, wherein the HMI controls include steering wheel controls.

15. A computer-implemented method comprising:
in an edit mode, updating a sequence of bookmarked user-interface screens responsive to a selection of a user-interface screen within one of a set of navigable categories of user-interface screens accessible via a gauge-cluster vehicle display; and
in a view mode, updating the gauge-cluster vehicle display to provide a next screen responsive to receiving input to transition to the next screen in the sequence of bookmarked user-interface screens.

16. The method of claim 15, wherein the set of navigable categories of user interface screens includes at least two of a trip/fuel category, a truck information category, a towing category, and an off-road category.

17. The method of claim 15, wherein the sequence of bookmarked user-interface screens includes a predetermined number of screens.

18. The method of claim 17, further comprising including, in the display, a page indication illustrating the predetermined number of screens and a location of the screen provided to the display within the sequence of bookmarked user-interface screens.

19. The method of claim 17, wherein the predetermined number of screens is between one and ten.

20. The method of claim 17, wherein the predetermined number of screens is at least ten.
